(19) United States
(12) Patent Application Publication
(10) Pub. No.: US 2023/0009577 A1
(43) Pub. Date: Jan. 12, 2023

(54) A SYSTEM AND METHOD FOR PROVIDING CONTEXTUAL INFORMATION AND ACTIONS TO MAKE A CONVERSATION MEANINGFUL AND ENGAGING

(71) Applicant: Pooran Prasad RAJANNA, Bangalore (IN)

(72) Inventor: Pooran Prasad RAJANNA, Bangalore (IN)

(21) Appl. No.: 17/782,731

(22) PCT Filed: Dec. 4, 2020
(86) PCT No.: PCT/IB2020/061482

§ 371 Date: Jun. 6, 2022

(30) Foreign Application Priority Data
Dec. 4, 2019 (IN) 201941022128

(51) Int. Cl. G06F 40/35; G06Q 10/10; G06F 40/166; H04W 4/16

(52) U.S. Cl. CPC G06F 40/35; G06F 40/166; G06Q 10/10; H04W 4/16

(57) ABSTRACT

The invention relates to a system (100) and method (200) for providing contextual information and actions to make a conversation meaningful and engaging. The method (200) comprises the steps of identifying a contact from various data sources (101) and collecting the relevant information from one or more web-based applications and databases, wherein the collected information is mapped to create one or more discussion points by one or more prediction servers (102). Post-conversation suggestions are provided by one or more suggestion servers (103), wherein the discussion points and the post-conversation suggestions are displayed on a user interface device (104) for allowing the user to have meaningful and engaging conversations.

### PRIORITY CLAIM

This application claims priority from the provisional application numbered 201941022128 filed with Indian Patent Office, Chennai on 4^{th} December 2019 titled “A system and method for providing contextual actions and suggestions to make a conversation meaningful and engaging”, the entirety of which is expressly incorporated herein by reference.

### PREAMBLE TO THE DESCRIPTION

The following specification particularly describes the invention and the manner in which it is to be performed:

### DESCRIPTION OF THE INVENTION

### Technical Field of the Invention

The present invention relates to a system and method for providing one or more contextual actions and suggestions and discussion points to make a conversation meaningful and engaging.

### Background of the Invention

Generally, before, during or after business calls and meetings, or while emailing, or researching, around 70% of the time is spent by the user looking up for the contact and organization related information and data from various application one has access to. The US pat. application “US20160072946A1” (referred herein as ’946) discloses a system and method for providing contextual information about the caller to make the conversation meaningful and engaging.

There is another set of information about the contact or organization they belong to, which is not in a structured format and readily available. For example, company news, organization information, and the organizations competitor information, for example, organization changes in top management, stock performance, press releases, events, competitors tracking, history of company, industry the company is part of, recent news, job changes, articles, announcements, etc. User has to manually do research lot of data, make notes, and be constantly updated and need to respond to changes in such data, The user has to go through many websites, data sources and manually gather such information. Further, the user has to come up with discussion points from the gathered contact information.

Hence, there is a need of a system and method for automatically providing contextual information about the contact and the organization they belong to, collated from various systems, that otherwise needs to be manually researched, along with data the user already has access to.

Such systems and method, needs to constantly search, save, monitor and update changes in data, like organization information, and the organizations competitor information, for example, organization changes in top management, stock performance, press releases, events, competitors tracking, history of company, industry the company is part of, recent news, articles, announcements, etc. Such semantically mapped information system, should proactively suggest the user to take some actions like events to attend, travel, meetings and appointments to follow up with the contact, and should also provide enough discussion points to start the conversation with the contact, to make the conversation meaningful and engaging.

### Summary of the Invention

The present invention overcomes the drawbacks of the prior art by providing a system and method for providing contextual actions and suggestions to make a conversation meaningful and engaging, wherein the system comprises one or more data sources for identifying a pre-defined contact person or organization by a user for making a contextual and meaningful conversation. One or more prediction servers collect the relevant information from one or more data sources and semantically map the collected and processed information to facilitate a meaningful conversation. Further, one or more suggestion servers receive the semantically mapped information from the prediction servers and provide post-conversation suggestions which are either pre-defined or dynamically added to a list by the suggestion servers. A user interface device displays the semantically mapped information from the prediction servers and the post-conversation suggestions which are added to a list by the suggestion servers for the purpose of making a conversation more meaningful and engaging.

The present invention provides a solution to the modern-day issue of having the ability to hold meaningful conversations. The method replaces the manual research work required to be done by a user with an intelligent and automatic solution which provides all the information that a user needs with minimum effort and time. Further, the method uses machine learning and artificial intelligence techniques to ensure that the user receives updated information which allows the user to have meaningful and engaging conversations.

### BRIEF DESCRIPTION OF THE DRAWINGS

The foregoing and other features of embodiments will become more apparent from the following detailed description of embodiments when read in conjunction with the accompanying drawings.

FIG. 1 illustrates a system for providing contextual information and actions for a contact, to make a conversation meaningful and engaging.

FIG. 2 illustrates a method for providing contextual information and actions for a contact, to make a conversation meaningful and engaging.

### DETAILED DESCRIPTION OF THE INVENTION

In order to make the matter of the invention clear and concise, the following definitions are provided for specific terms used in the following description.

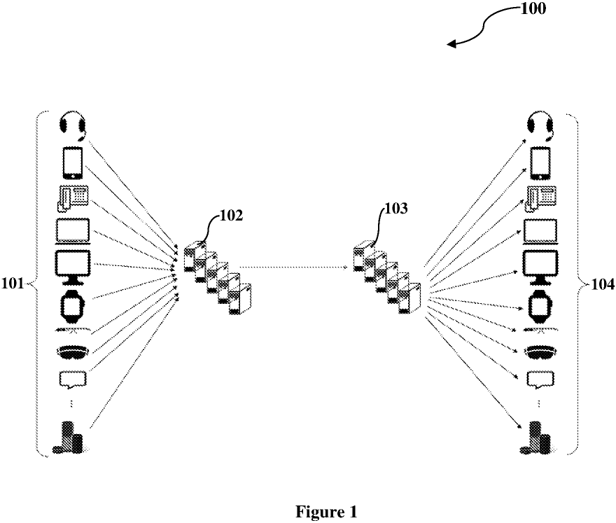

FIG. 1 illustrates a system for providing contextual information and actions for a contact, to make a conversation meaningful and engaging, wherein the system (100) comprises at least one data source (101) for identifying a pre-defined contact person or organization by a user for making a contextual and meaningful conversation. The data sources (101) may be various sources like incoming or outgoing calls from mobile, desk phone or VOIP call, or incoming mail, chat request, voice request, meeting, task, reminder, visual request, or push notification from applications, or any kind of input or trigger, or by clicking on a contact from a contact list or suggestion card or searching for the contact, on any device of the user and identify a contact associated it , for which the user has provided access to.

A prediction server (102) collects the relevant information from one or more data sources (101), wherein the prediction server (102) semantically maps the collected and processed information to facilitate a meaningful conversation. The prediction server (102) periodically saves, monitors and updates information pertaining to a person or organization based on the input data obtained from a plurality of data sources (101) and semantically maps a pre-defined contact with an organization and subsequently extracts information pertaining to the organization using a plurality of data sources (101).

In an embodiment, the prediction server (102) associates each contact with an organization, and continuously extracts relevant information about the organization, and the organizations competitor information from various data sources (101). The prediction server (102) saves monitors and updates organization information, and the organizations competitor information, for example, organization changes in top management, stock performance, press releases, events, competitors tracking, history of company, industry the company is part of, recent news, articles, announcements, etc.

Further, a suggestion server (103) receives the semantically mapped information from the prediction server (102), wherein the suggestion server (103) dynamically provides discussion points and contextual actions based on the semantically mapped contact information obtained from the continuously searched, monitored and updated contact information from the prediction server (102). The discussion points could be, for example, related to company, industry they are part of, recent news, articles, announcements etc., in order to trigger a conversation with the contact, based on the semantically mapped organization information obtained from the prediction server (102).

In an embodiment, the system (100) upon detecting triggered events such as incoming or outgoing calls from mobile, desk phone or VOIP call, or incoming mail, chat request, voice request, meeting, task, reminder, visual request, or push notification from applications, or any kind of input or trigger, or by clicking on a contact from a contact list or suggestion card or searching for the contact, on any device of the user, suggests one or more suggestions, contextual actions and discussion points which may be predefined or dynamically added to the list by the suggestion server (103). Once a termination event such as termination of incoming or outgoing call, end of meeting, completion of task or reminder, in an embodiment, suitable post call actions, for example, setting agenda for the user to follow-up with the contact, finding suitable time-slots while going through a calendar application installed in the mobile device associated with the user, or suggesting events that the user may add to the calendar application present in the mobile device of the user, is indicated to user.

The system (100) comprises a user interface device (104) such as a tablet computing device, a desktop computer, a mobile communication device, a laptop computer, a laptop/tablet hybrid computing device, a large screen multi-touch display, a gaming device, a smart television, a wearable device, a connected automobile, a smart home device, an “Internet of Things” (IoT) device and so on for displaying the semantically mapped information from the prediction server (102) and the post-conversation suggestions which are added to a list by the suggestion server (103) for the purpose of making a conversation more meaningful and engaging. In one embodiment, the system (100) may collect relevant information about the identified contact from all the applications the user has provided permission to search and display the collected information as one-page summary on a user interface device (104) which may be a primary or secondary display device configured by the user.

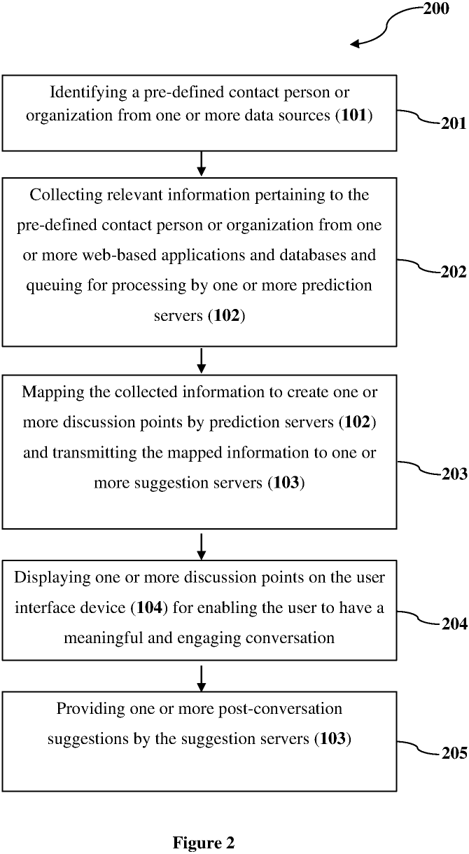

FIG. 2 illustrates a method for providing contextual information and actions for a contact, to make a conversation meaningful and engaging, wherein the method (200) comprises the steps of identifying a pre-defined contact person or organization from one or more data sources (101), wherein a user allows the method (100) to access the data sources (101) for the purpose of contact identification in step (201), wherein the access may be from any existing applications like Email, Customer Relation Management systems, Customer Support applications, Customer Success Applications, internal applications and so on. The various data sources (101) may include incoming or outgoing calls from mobile, desk phone, VOIP call, incoming mail, chat request, voice request, visual request, push notification from applications, online meetings, physical meetings, email, reminders or tasks or any kind of input or trigger, or by clicking on a contact from a contact list or a suggestion card or searching for the contact, on any user interface device (104) associated with the user. In step (202), the method (200) collects relevant information pertaining to the pre-defined contact person or organization from one or more web-based applications and databases, wherein the collected information is queued for processing by one or more prediction servers (102).

In an embodiment, the prediction server (102) searches for the organization information from various data sources (101), for example, from various country specific company information services, third party web services such as LinkedIn, social networks, data services, industry data sources, and collect information that could be relevant for discussion, including, but not limited to organization information, and the organizations competitor information, for example, organization changes in top management, stock performance, press releases, events, competitors tracking, history of company, industry the company is part of, recent news, articles, announcements, etc.

In step (203), the prediction servers (103) semantically map all the data collected using various algorithms, continuously to prepare a list of discussion points which are transmitted to one or more suggestion servers (103). Detecting triggered events such as incoming call, outgoing call, call ending, before or after physical or online meeting, task or a reminder, writing an email, or just browsing, when user is looking at contact or organization on any device where the system is installed, some of the details of alerts leading to user seeing the contacts are highlighted in ’946. In addition to the data from the data sources (101), the user has provided access to, as detailed in 946, the method (200) also displays the suggestions, contextual actions and discussion points such as information related to company, industry they are part of, recent news, articles, announcements and so on on a user interface device (104) in step (204).

In step (205), one or more post-conversation suggestions, contextual actions and discussion points are provided in termination events such as termination of incoming or outgoing call, end of meeting, completion of task or reminder, are provided by the suggestion servers (103), wherein the post-conversation suggestions are either pre-defined or dynamically added to a list by the suggestion server (103). In an embodiment, the post call actions include, for example, setting agenda for the user to follow-up with the contact, finding suitable time-slots while going through a calendar application installed in the user interface device (104) associated with the user, or suggesting events that the user can add to the calendar application present in the user interface device (104) of the user.

The description of the present system has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

I claim:

1. A system for providing contextual actions and suggestions to make a conversation meaningful and engaging, the system (100) comprising:
a. at least one data source (101) for identifying a pre-defined contact person or organization by a user for making a contextual and meaningful conversation;
b. at least one prediction server (102) for collecting the relevant information from one or more data sources (101), wherein the prediction server (102) semantically maps the collected and processed information to facilitate a meaningful conversation;
c. at least one suggestion server (103) which receives the semantically mapped information from the prediction server (102), wherein the suggestion server (103) provides post-conversation suggestions which are either pre-defined or dynamically added to a list by the suggestion server (103);
d. at least one user interface device (104) for displaying the semantically mapped information from the prediction server (102) and the post-conversation suggestions which are added to a list by the suggestion server (103) for the purpose of making a conversation more meaningful and engaging.

2. The system (100) as claimed in claim 1, wherein the prediction server (102) periodically saves, monitors and updates information pertaining to a person or organization based on the input data obtained from a plurality of data sources (101).

3. The system (100) as claimed in claim 1, wherein the prediction server (102) semantically maps a pre-defined contact with an organization and subsequently extracts information pertaining to the organization using a plurality of data sources (101).

4. The system (100) as claimed in claim 1, wherein the suggestion server (103) dynamically provides post-conversation suggestions and contextual actions based on the semantically mapped contact information provided by the prediction server (102) using machine learning techniques.

5. The system (100) as claimed in claim 1, wherein the suggestion server (103) transmits pro-active alerts to the user interface device (104) depending on the criticality or time sensitive notifications to enable a user to be updated regarding topics related a pre-defined contact person or organization.

6. A method for providing contextual actions and suggestions to make a conversation meaningful and engaging, the method (200) comprising the steps of:
a. identifying a pre-defined contact person or organization from one or more data sources (101), wherein a user allows the method (100) to access the data sources (101) for the purpose of contact identification;
b. collecting the relevant information pertaining to the pre-defined contact person or organization from one or more web-based applications and databases, wherein the collected information is queued for processing by one or more prediction servers (102);
c. mapping the collected information to create one or more discussion points by one or more prediction servers (102), wherein the discussion points are transmitted to one or more suggestion servers (103);
d. displaying one or more suggestions, contextual actions and discussion points on the user interface device (104) for enabling the user to have a meaningful and engaging conversation;
e. providing one or more post-conversation suggestions, contextual actions and discussion points by the suggestion servers (103), wherein the post-conversation suggestions are either pre-defined or dynamically added to a list by the suggestion server (103).

7. The method (200) as claimed in claim 6, wherein triggered events are detected on the user interface device (104) subsequent to which the suggestion server (103) suggests one or more suggestions, contextual actions and discussion points which are either predefined or dynamically added to the list to allow the user to have a meaningful and engaging conversation.

8. The method (200) as claimed in claim 6, wherein the suggestion server (103) detects termination events and suggests suitable post conversation actions, and suggestions for user.
